(19) United States
(12) Patent Application Publication
(10) Pub. No.: US 2012/0143788 A1
(43) Pub. Date: Jun. 7, 2012

(54) TOXIN DETECTION SYSTEM AND METHOD

(75) Inventor: Joel Bock, La Mesa, CA (US)

(73) Assignee: HONEYWELL INTERNATIONAL INC., Morristown, NJ (US)

(21) Appl. No.: 12/507,589

(22) Filed: Jul. 22, 2009

(51) Int. Cl. G06F 15/18; G06N 5/02

(52) U.S. Cl. 706/12; 706/46

(57) ABSTRACT

A system and method of generating a generic binary classifier for the presence of one or more toxins in water is provided. Features are extracted from a plurality of normalized a priori data sets that include one or more control data sets that are representative of an electric cell-substrate impedance sensor (ECIS) response to water with no toxins therein, and a plurality of treatment data sets that are representative of an ECIS response to water with a toxin therein. A plurality of classifier algorithms are trained using the extracted features, and a plurality of classification models are generated from each of the trained classifier algorithms. Each of the classification models is evaluated and, based on the evaluation of each classification model, a subset thereof is selected. The selected subset of the classification models is supplied as the generic binary classifier.

### STATEMENT REGARDING FEDERALLY SPONSORED RESEARCH OR DEVELOPMENT

This invention was made with Government support under contract number DAMD17-01-C-0011 awarded by the U.S. Army. The Government has certain rights in this invention.

### TECHNICAL FIELD

The present invention generally relates to toxin detection, and more particularly relates to a system and method of developing models for detecting toxins, preferably in drinking water, based on data supplied from biosensors.

### BACKGROUND

The purity of municipal water supplies has always been a relatively high priority of citizens and their governing bodies. Recently, and albeit unfortunately, concern has arisen regarding the purposeful introduction of harmful chemicals into a municipal water supply. In response to these concerns, various entities, including various governmental entities, have initiated programs to develop the capability to detect the presence of harmful chemicals in water.

Various initiatives have developed around biologically-based sensors, such as electric cell-substrate impedance sensors (ECIS). Unfortunately, when exposed to relatively low concentrations of some chemicals, the response of an ECIS can be statistically indistinguishable from exposure to clean water. As a result, presently known methods for processing data from an ECIS do not provide sufficiently high sensitivity and sufficiently low false positive rates, especially at relatively low concentration levels.

Hence, there is a need for system and method of detecting toxins in water, early in time after exposure, with relatively high sensitivity and low false positive rates. The present invention addresses at least this need.

### BRIEF SUMMARY

In one exemplary embodiment, a method of generating a generic binary classifier for the presence of one or more toxins in water includes extracting features from a plurality of normalized a priori data sets that include one or more control data sets and a plurality of treatment data sets. The one or more control data sets are representative of an electric cell-substrate impedance sensor (ECIS) response to water with no toxins therein, and each of the plurality of treatment data sets is representative of an ECIS response to water with a toxin therein. A plurality of classifier algorithms are trained using the extracted features, and a plurality of classification models are generated from each of the trained classifier algorithms. Each of the classification models is evaluated and, based on the evaluation of each classification model, a subset thereof is selected. The selected subset of the classification models is supplied as the generic binary classifier.

In another exemplary embodiment, a method of producing a toxin-in-water detection system includes extracting features from a plurality of normalized a priori data sets that include one or more control data sets and a plurality of treatment data sets. The one or more control data set are representative of an electric cell-substrate impedance sensor (ECIS) response to water with no toxins therein, each of the plurality of treatment data sets is representative of an ECIS response to water with a toxin therein. A plurality of classifier algorithms are trained using the extracted features, and a plurality of classification models are generated from each of the trained classifier algorithms. Each of the classification models is evaluated and, based on the evaluation of each classification model, a subset thereof is selected. A processor is then configured to run at least the selected subset of classification models, and an ECIS is coupled to the processor.

In still another exemplary embodiment, a toxin-in-water detection system includes an electric cell-substrate impedance sensor (ECIS) and a processor. The ECIS is adapted to receive a flow of water and configured to supply ECIS data. The processor is coupled to receive the ECIS data and implements a generic binary classifier. The generic binary classifier is configured, in response to the ECIS data, to determine whether a toxin is present in the water. The generic binary classifier that is implemented by the processor was generated by extracting features from a plurality of normalized a priori data sets that include one or more control data sets and a plurality of treatment data sets. The one or more control data sets are representative of an electric cell-substrate impedance sensor (ECIS) response to water with no toxins therein, and each of the plurality of treatment data sets is representative of an ECIS response to water with a toxin therein. A plurality of classifier algorithms are trained using the extracted features, and a plurality of classification models are generated from each of the trained classifier algorithms. Each of the classification models is evaluated and, based on the evaluation of each classification model, a subset thereof is selected. The selected subset of the classification models is supplied as the generic binary classifier.

Furthermore, other desirable features and characteristics of the methods and systems will become apparent from the subsequent detailed description and the appended claims, taken in conjunction with the accompanying drawings and preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of a toxin-in-water detection system according to an exemplary embodiment of the present invention;

FIG. 2 depicts the overall process, in flowchart form, that is used to generate a generic binary classifier that is implemented by a processor of FIG. 1;

FIG. 3 depicts an exemplary embodiment, in flowchart form, of a preprocessing methodology;

FIG. 4 depicts an exemplary embodiment, in flowchart form, of a feature extraction process;

FIGS. 5 and 6 depict exemplary results of the feature extraction process of FIG. 4 for control data sets and treatment data sets, respectively;

FIG. 7 depicts a close up representation of local structures in early time segments for the exemplary results of FIGS. 5 and 6;

FIG. 8 depicts, if flowchart form, an exemplary build-and-evaluate process; and

FIG. 9 depicts an embodiment of a process, in flowchart form, that the generic classifier may implement.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

It is additionally noted that embodiments of the present invention may be described in terms of functional block diagrams and various processing steps. It should be appreciated that such functional blocks may be realized in many different forms of hardware, firmware, and/or software components configured to perform the various functions. For example, the present invention may employ various integrated circuit components, e.g., memory elements, digital signal processing elements, look-up tables, and the like, which may carry out a variety of functions under the control of one or more microprocessors or other control devices. Such general techniques are known to those skilled in the art and are not described in detail herein. Moreover, it should be understood that the exemplary process illustrated may include additional or fewer steps or may be performed in the context of a larger processing scheme. Furthermore, the various methods presented in the drawing Figures or the specification are not to be construed as limiting the order in which the individual processing steps may be performed. It should be appreciated that the particular implementations shown and described herein are illustrative of the invention and its best mode and are not intended to otherwise limit the scope of the invention in any way.

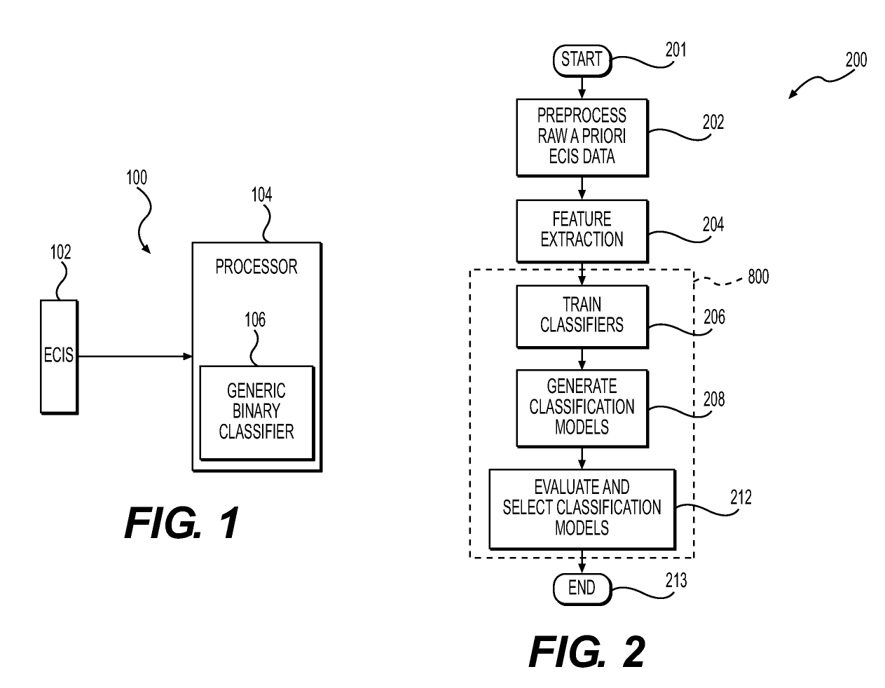

Referring first to FIG. 1, and exemplary embodiment of a toxin-in-water detection system 100 is depicted, and includes a biosensor 102 and a processor 104. The biosensor 102 is preferably an electric cell-substrate impedance sensor (ECIS). The ECIS 102 is adapted to receive a flow of water and is configured to supply ECIS data. As is generally known, an ECIS includes relatively small electrodes that have cells grown on the surfaces thereof. The cells, due to the insulating properties of their membranes, exhibit impedance variations in response to variations in various physical phenomena. One of these phenomena is the presence of various chemicals. Hence, the ECIS data that are supplied from the ECIS sensor 102 are representative of impedance variations in response to variations in toxic chemical concentrations in the water flowing therethrough.

The processor 104 is coupled to receive the ECIS data from the ECIS sensor 102, and implements a generic binary classifier 106. The generic binary classifier 106 is configured, in response to the ECIS data, to determine whether a toxin is present in the water. The generic binary classifier 106 that is implemented by the processor 104 determines the presence or absence of one or more toxins in the water with both a relatively high sensitivity and a relatively low false positive rate. As used herein, a false positive means a determination that a toxin is present when one actually is not present.

The generic binary classifier 106 is generated in accordance with a process that will be explained momentarily. Before doing so, however, it is noted that the processor 104 may be implemented using any one or more of numerous known general-purpose microprocessors and/or application specific processors that operate in response to program instructions. It will be appreciated that the processor 104 may be implemented using various other circuits, not just a programmable processor. For example, digital logic circuits and analog signal processing circuits could also be used.

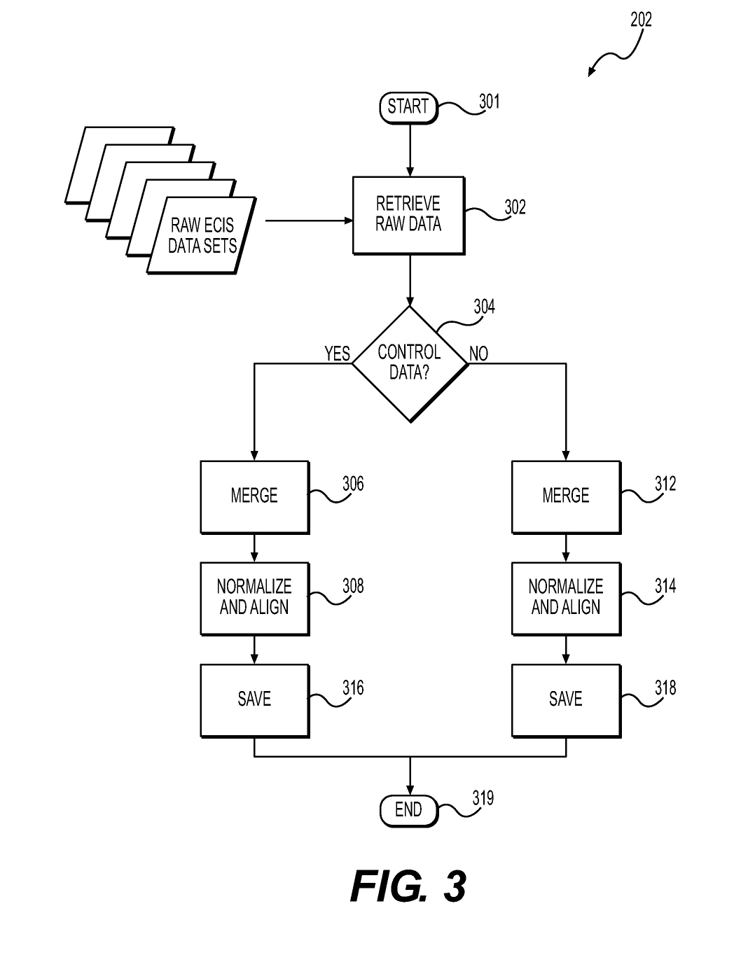

Turning now to FIG. 2, the overall process that is used to generate the generic binary classifier 106 that is implemented by the processor 106 is depicted in flowchart form, and will now be explained. In doing so, it should be understood that the parenthetical references in the following paragraphs refer to like-numbered flowchart blocks in FIG. 2 and all subsequently referenced flowcharts. As FIG. 2 depicts, the overall process 200 begins by preprocessing raw a priori ECIS data sets (202) to generate normalized a priori data sets. Thereafter, features are extracted from the normalized a priori data sets (204), and these extracted features are used to train a plurality of classifier algorithms (206). A plurality of classification models are generated from the trained classifier algorithms (208). The classification models are then evaluated and, based on the evaluations, a subset of the classification models are selected (212). The subset of classification models that are selected are used to implement the generic binary classifier 106. Each of these processing steps (202-212) will now be described in more detail.

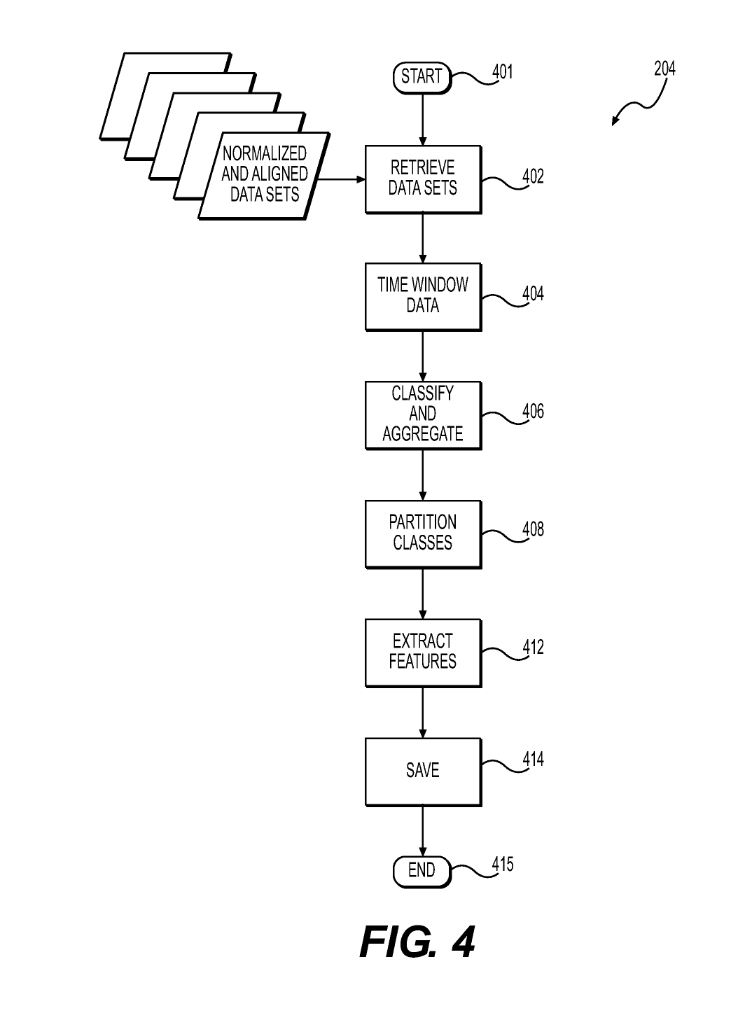

An exemplary embodiment of how the preprocessing of the raw a priori ECIS data sets (202) is implemented is depicted in FIG. 3. This process (202), which is preferably executed first, prepares the raw a priori ECIS data sets for subsequent processing. Before describing this process, it is noted that the raw a priori ECIS data sets include one or more (preferably plural) control data sets and a plurality of treatment data sets from various experimental runs. The control data sets include data representative of an ECIS response to water with no toxins therein, and the plurality of treatment data sets include data that are representative of an ECIS response to water with a toxin therein.

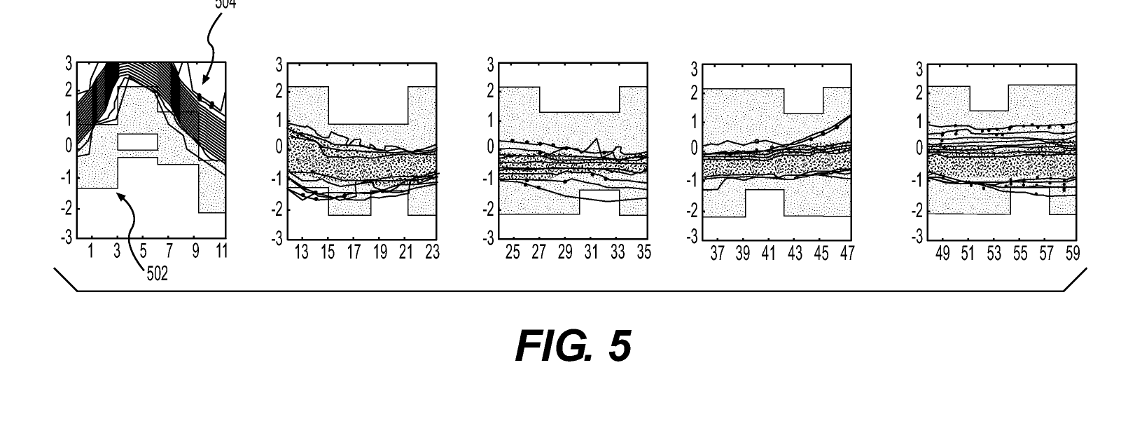

The preprocessing (202) begins by retrieving each of the raw a priori ECIS data sets (302), and determining which of the raw a priori ECIS data sets are control data sets (304). Those data sets that are control data sets are merged (306), and then normalized and aligned for subsequent processing (308). It is noted that, at least in the depicted embodiment, the generic binary classifier 106 is implemented as a single, unified toxicity detection model for general applicability in an environment in which the chemical contaminant is unknown. Hence, all of the treatment data sets, regardless of chemical species or concentration, are combined into a single “class.” This is why, similar to the control data sets, all of the treatment data sets are merged (312), and then normalized and aligned for subsequent processing (314). It will be appreciated, however, that in some embodiments, the treatment data sets may be separately classified according to the specific toxin and/or as an unknown toxin. In such embodiments, the treatment data sets are individually preprocessed by toxin type, if known, and/or as unknown toxins. As FIG. 3 further depicts, the normalized and aligned a priori ECIS data sets may be saved, if needed or desired, as XML-formatted files (316, 318). In any case, the normalized and aligned a priori ECIS data sets may then be supplied to the feature extraction process (204), which is depicted in FIG. 4 and will now be described in more detail.

The extraction of features from the normalized and aligned a priori ECIS data sets begins by first loading the normalized and aligned a priori ECIS data sets (402). Thereafter, the time histories of one or more of the loaded ECIS data sets are truncated (404), if needed, so that each ECIS data set contains the same number of data points. This ensures, among other things, a common sampling rate, and also checks for consistent time units. After the ECIS data sets are time truncated for consistency, the ECIS data sets are classified according to type and then aggregated (406). More specifically, each ECIS data set is classified as a control data set, a data set for a specific toxin, a data set for a plurality of toxins, or a data set for an unknown toxin. The classified data sets are then aggregated into structures based on classification.

The aggregated data within the structures are partitioned into two classes (408), which are referred to herein as a control class (e.g., no toxin present) and a treatment class (toxin present). Then, features are extracted from the partitioned data (412), and are stored in suitable files (414), preferably in Attribute-Relation File Format (ARFF) format. The ARFF format is preferred because of its compatibility with certain open source libraries for machine learning. Before proceeding further, it should be noted that, as with the preprocessing process (202), the treatment data sets may be separately processed according to the specific (and/or unknown) toxin.

It will furthermore be appreciated that the specific features that are extracted, and the feature extraction algorithms used, may vary. In a particular preferred embodiment, however, a symbolic representation of time series feature extraction algorithm is used. In accordance with this methodology, local histograms of amplitude data are constructed at sequential segments of time series (e.g., “temporal bins”). The counts accumulated in these temporal bins are taken to represent a local structure within a specified interval of time. If the local structures include sufficient information, then the structures may be used to train a pattern recognition algorithm. The trained algorithm may then be used to predict the class (e.g., toxin present or toxin not present) of subsequent data. An example of this type of feature extraction algorithm is disclosed in a publication entitled, “A Symbolic Representation of Time Series, With Implications for Streaming Algorithms,” which was authored by J. Lin et al., and published in the Proceedings of the 8^{th} ACM SIGMOD Workshop on Research Issues in Data Mining and Knowledge Discover, San Diego, Calif. (2003). The entirety of this publication is hereby incorporated by reference.

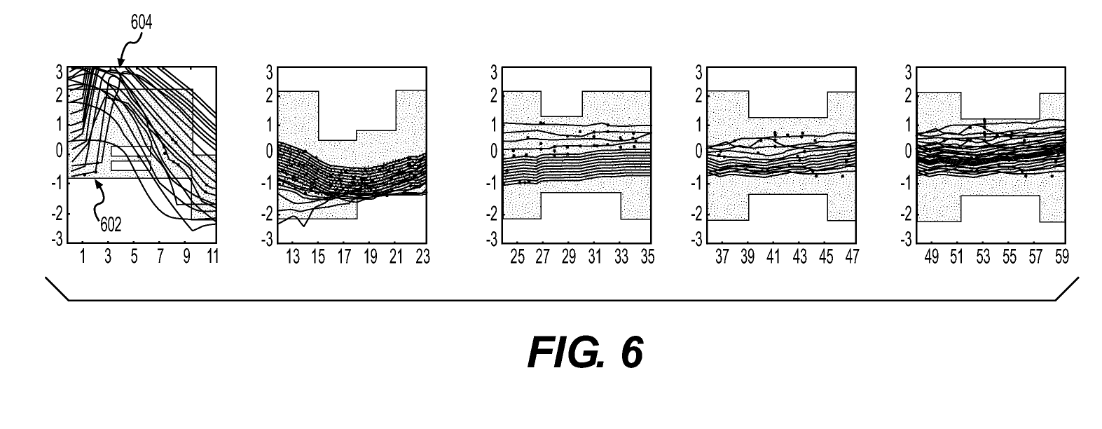

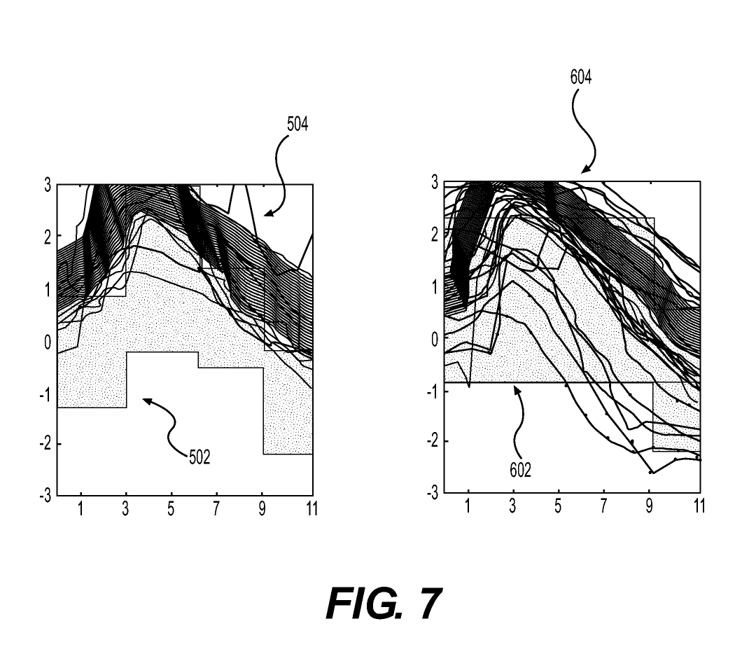

As an example of the feature extraction algorithm described above, reference should be made to FIGS. 5 and 6, which depict exemplary results for control data sets and treatment data sets, respectively. In both FIGS. 5 and 6, the data sets are partitioned into five contiguous segments of time series. The rectangular regions 502, 602 represent the symbols used to assemble histograms of local structure, and the lines and dots 504, 604 are the normalized values of the underlying time series. The instant inventor discovered that the early time segments, which are shown side-by-side in FIG. 7, have sufficiently disparate local structures to allow discrimination between control and exposure data, thereby facilitating early-time detection of toxins in water.

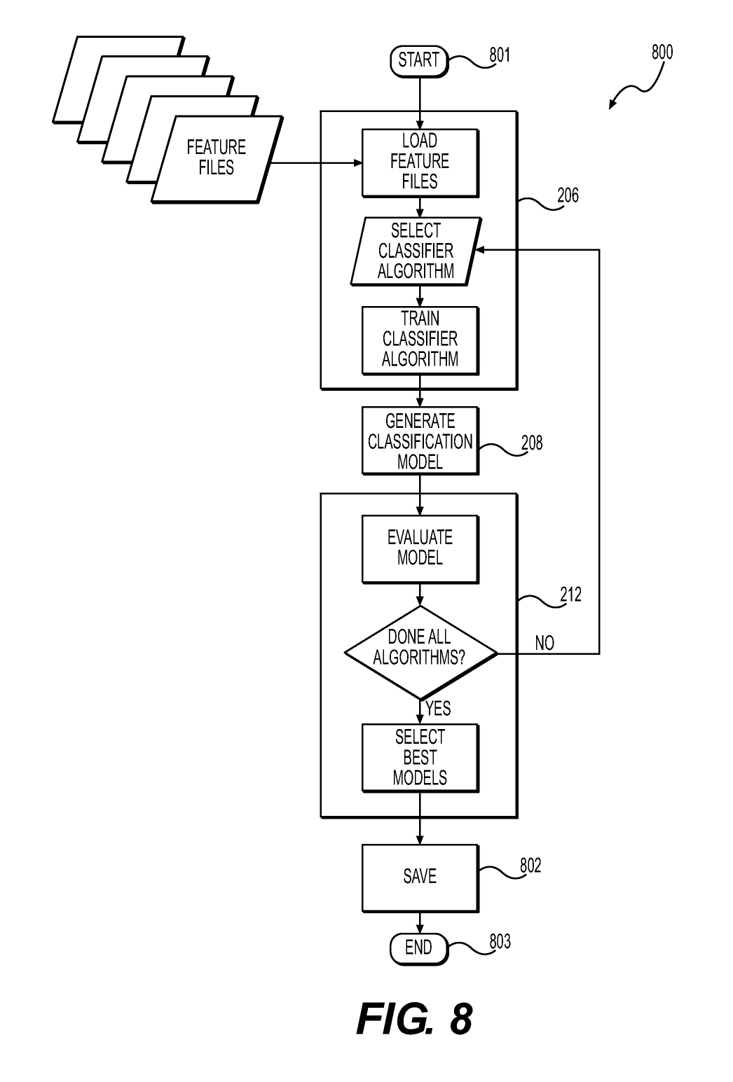

The training of classifier algorithms (206), the generation of classification models (208), and classification model evaluations and selections (212) that are used to generate the generic binary classifier 106 are depicted in flowchart form in FIG. 8 as being part of a single build-and-evaluate process 800. The build-and-evaluate process 800 trains the classifier algorithms (206), generates the classification models (208), and evaluates and selects the classification models (212). The classification models that are selected are those that exhibit relatively low FPR performance (e.g., FPR<0.1%) for control data sets. The selected classification models are referred to herein as the subset of classification models that is used as the generic binary classifier 106. As FIG. 8 further depicts, the selected classification models are saved (802). It will be appreciated that the classification algorithms used to implement this process 800 could be numerous and varied. In a particular preferred implementation, three classification algorithms are used. These are the Voted Perceptron algorithm, the Bayesian Network algorithm, and the Support Vector Machine algorithm.

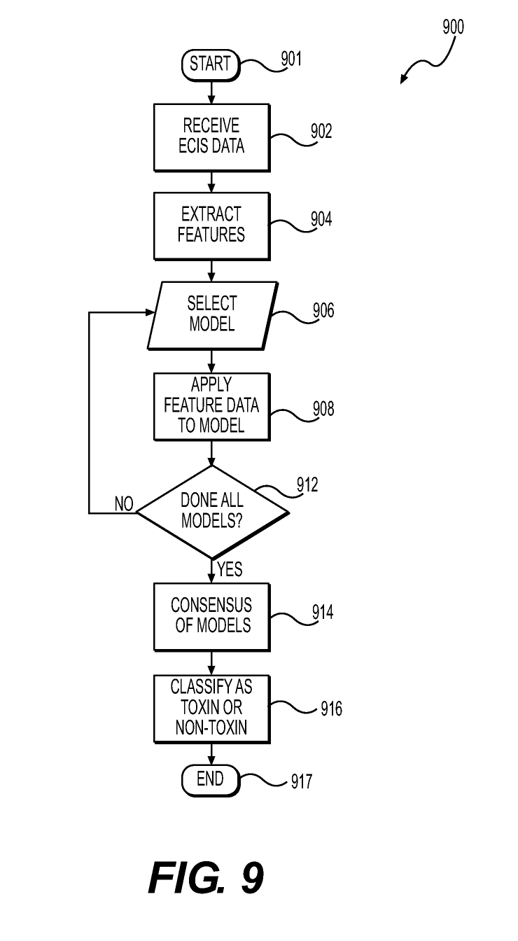

The generic binary classifier 106 that is generated evaluates unknown ECIS data to determine whether a toxin is present in water flowing through the ECIS sensor 102. An embodiment of the process 900 that the generic classifier 106 implements is depicted in FIG. 9, and with reference thereto, will now be described. The generic binary classifier 106 receives the ECIS data supplied from the ECIS 102 (902), and extracts features therefrom (904). The generic binary classifier 106 then selects one of the subset of models (906) and applies the extracted features to the model (908). These previous step (908) is repeated until the extracted features are supplied each of the models of the subset of models (912).

After the extracted features have been applied to each of the models, the consensus of each of the models is determined (914). More specifically, a simple voting scheme is implemented using the result of each of the models and a predetermined detection threshold. Based on the determined consensus, the determination is made as to whether to classify the ECIS data as representative of the presence of a toxin or no toxin (916). It is noted that if a majority of the models indicate the presence of a toxin, then the ECIS data are classified as representative of the presence of a toxin; otherwise, the data re classified as representative of no toxin.

The system and method described herein provide for the detection of toxins in water, early in time after exposure, with relatively high sensitivity and low false positive rates.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of generating a generic binary classifier for the presence of one or more toxins in water, comprising the steps of:
extracting features from a plurality of normalized a priori data sets, the normalized a priori data sets including one or more control data sets and a plurality of treatment data sets, the one or more control data sets representative of an electric cell-substrate impedance sensor (ECIS) response to water with no toxins therein, each of the plurality of treatment data sets representative of an ECIS response to water with a toxin therein;
training a plurality of classifier algorithms using the extracted features;
generating a plurality of classification models from each of the trained classifier algorithms;
evaluating each of the classification models and, based on the evaluation of each classification model, selecting a subset thereof;
supplying the selected subset of the classification models as the generic binary classifier.

2. The method of claim 1, further comprising:
preprocessing one or more raw a priori control data sets and a plurality of a priori raw treatment data sets to thereby generate the plurality of normalized a priori data sets.

3. The method of claim 1, wherein the step of extracting features is based on a symbolic representation of time series algorithm.

4. The method of claim 1, wherein the step of evaluating each of the classification models comprises:
determining a false positive rate (FPR) of each classification model; and
comparing the determined FPR to a predetermined FPR threshold.

5. The method of claim 4, further comprising selecting a classification model as part of the subset if the determined FPR is less than the predetermined FPR threshold.

6. The method of claim 1, wherein the step of evaluating each of the classification models comprises:
determining a true positive rate (TPR) of each classification model; and
comparing the determined TPR to a predetermined TPR threshold.

7. The method of claim 6, further comprising selecting a classification model as part of the subset if the determined TPR is greater than the predetermined TPR threshold.

8. A method of producing a toxin-in-water detection system, comprising the steps of:
extracting features from a plurality of normalized a priori data sets, the normalized a priori data sets including one or more control data sets and a plurality of treatment data sets, the one or more control data set representative of an electric cell-substrate impedance sensor (ECIS) response to water with no toxins therein, each of the plurality of treatment data sets representative of an ECIS response to water with a toxin therein;
training a plurality of classifier algorithms using the extracted features;
generating a plurality of classification models from each of the trained classifier algorithms;
evaluating each of the classification models and, based on the evaluation of each classification model, selecting a subset thereof;
configuring a processor to run at least the selected subset of classification models; and
coupling an ECIS to the processor.

9. The method of claim 8, further comprising:
preprocessing one or more raw a priori control data sets and a plurality of a priori raw treatment data sets to thereby generate the plurality of normalized a priori data sets.

10. The method of claim 8, wherein the step of extracting features is based on a symbolic representation of time series algorithm.

11. The method of claim 8, wherein the step of evaluating each of the classification models comprises:
determining a false positive rate (FPR) of each classification model; and
comparing the determined FPR to a predetermined FPR threshold.

12. The method of claim 11, further comprising selecting a classification model as part of the subset if the determined FPR is less than the predetermined FPR threshold.

13. The method of claim 11, wherein the step of evaluating each of the classification models comprises:
determining a true positive rate (TPR) of each classification model; and
comparing the determined TPR to a predetermined TPR threshold.

14. The method of claim 13, further comprising selecting a classification model as part of the subset if the determined TPR is greater than the predetermined TPR threshold.

15. A toxin-in-water detection system, comprising:
an electric cell-substrate impedance sensor (ECIS) adapted to receive a flow of water and configured to supply ECIS data; and
a processor coupled to receive the ECIS data and configured to implement a generic binary classifier, the generic binary classifier configured, in response to the ECIS data, to determine whether a toxin is present in the water, wherein the generic binary classifier was generated by:
extracting features from a plurality of normalized a priori data sets, the normalized a priori data sets including one or more control data sets and a plurality of treatment data sets, the one or more control data sets representative of an electric cell-substrate impedance sensor (ECIS) response to water with no toxins therein, each of the plurality of treatment data sets representative of an ECIS response to water with a toxin therein,
training a plurality of classifier algorithms using the extracted features,
generating a plurality of classification models from each of the trained classifier algorithms,
evaluating each of the classification models and, based on the evaluation of each classification model, selecting a subset thereof,
supplying the selected subset of the classification models as the generic binary classifier.

16. The system of claim 15, wherein the generic binary classifier:
supplies the received ECIS to each of the selected subset of classification models; and
determines whether a toxin is present in the water based on outputs from all of the selected subset of classification models.

17. The system of claim 15, wherein the generic binary classifier was generated additionally by preprocessing one or more raw a priori control data sets and a plurality of a priori raw treatment data sets to thereby generate the plurality of normalized a priori data sets.

18. The system of claim 15, wherein the generic binary classifier was generated additionally by extracting features based on a symbolic representation of time series algorithm.

19. The system of claim 15, wherein the generic binary classifier was generated additionally by of evaluating each of the classification models by:
determining a false positive rate (FPR) of each classification model;
comparing the determined FPR to a predetermined FPR threshold; and
selecting a classification model as part of the subset if the determined FPR is less than the predetermined FPR threshold.

20. The system of claim 15, wherein the generic binary classifier was generated additionally by of evaluating each of the classification models by:
determining a true positive rate (TPR) of each classification model;
comparing the determined TPR to a predetermined TPR threshold; and
selecting a classification model as part of the subset if the determined TPR is greater than the predetermined TPR threshold.
